(19) United States
(12) Patent Application Publication
(10) Pub. No.: US 2021/0331402 A1
(43) Pub. Date: Oct. 28, 2021

(54) 3D PRINTING CONTROL

(71) Applicant: HEWLETT-PACKARD DEVELOPMENT COMPANY, L.P., Spring, TX (US)

(72) Inventors: Ismael Fernandez Aymerich, Sant Cugat del Valles (ES); Pol Fornos Martinez, Sant Cugat del Valles (ES); Manuel Freire Garcia, Sant Cugat del Valles (ES)

(21) Appl. No.: 16/605,225

(22) PCT Filed: Jun. 28, 2018
(86) PCT No.: PCT/US2018/039952

§ 371 Date: Oct. 15, 2019

(51) Int. Cl. B29C 64/393; B29C 64/165; B29C 64/264; B33Y 10/00; B33Y 30/00; B33Y 50/02

(52) U.S. Cl. CPC B29C 64/393; B29C 64/165; B33Y 50/02; B33Y 10/00; B33Y 30/00; B29C 64/264

(57) ABSTRACT

An example method to control a 3D printing system is described. In that example a print agent is selectively deposited onto a portion of a build material layer and based on a reflectance of the portion of the build material layer, an amount of energy to be applied to the portion is determined.

### BACKGROUND

In 3D printing technology three-dimensional objects can be generated in a layer-wise manner. In some examples, layers of build material are successively formed on a build platform and portions of successive layers may be selectively solidified to form the layers of a three-dimensional object. In some examples, a selective solidification process includes depositing a print agent and uniform application of energy.

### BRIEF DESCRIPTION OF THE DRAWINGS

FIG. 1 schematically shows an example of a 3D printing system.

FIG. 2 schematically shows an example of a 3D printing system.

FIGS. 3a and 3b schematically show an example of a 3D printing system.

FIGS. 4a and 4b schematically show an example of a 3D printing system.

FIG. 5 schematically shows an example of a 3D printing system.

FIGS. 6a and 6b schematically show an example of a 3D printing system.

FIGS. 6c, 6d and 6e schematically show parameters of a method to control a 3D printing system.

FIG. 7 schematically shows an example of a computer readable storage medium comprising instructions to control a 3D printing system, the instructions executable by a processor.

FIG. 8 shows a flow diagram of an example of a method to control a 3D printing system.

FIG. 9 shows a flow diagram of an example of a method to control a 3D printing system.

FIG. 10 shows a flow diagram of an example of a method to control a 3D printing system.

### DETAILED DESCRIPTION

Three-dimensional objects may be generated from build material. In some examples, build material may comprise dry and wet powders. Each powder particle may have a shape, e.g. spherical, ellipsoidal, fiber-shaped, polyhedron-shaped or another shape, and dimension. In some examples, build material may be plastic powder, such as nylon, polyamide, polypropylene, or metal powder, ceramic powder or another composition.

In some examples, consecutive layers of build material are formed and portions per build material layer are selectively solidified, so that layer-by-layer solidified portions of build material form a three-dimensional object. For example, portions per build material layer may be locations of the build material layer defined by a slice representation of a set of three-dimensional objects to be built, e.g. cross-sections. Solidification of build material may be based, for example, on melting, binding, sintering, fusing, curing, polymerization or coalescing.

In some examples, a print agent, such as an energy absorbing print agent, fusing agent or a coalescing agent, is deposited onto sections of a build material layer. In an example, energy absorbing print agent may be, or may be based on, black ink, for example comprising carbon black, and may be deposited by a printhead of a 3D printing system. In other examples, other print agents may be used. When energy is applied to a layer of build material, such as by a uniform energy source of a 3D printing system, sections of the build material layer on which energy absorbing print agent has been applied absorb more electromagnetic radiation and heat up more than sections of a build material layer on which no energy absorbing print agent was applied. Such sections may melt or fuse together, forming a solidified portion of build material.

In some examples, solidification processes of portions of a build material layer and thus appearance and physical properties of a final three-dimensional object may depend on an energy and temperature control of the 3D printing process. For example, warpage of solidified portions of build material, thermal bleed or inhomogeneous solidification of portions of a build material layer may influence, for example, dimensional accuracy and final three-dimensional object quality. It may be desired to control the amount of energy absorbed by portions of a build material layer so that portions of a build material layer heat up to a predetermined temperature, such as a temperature related to a melting temperature, a glass transition temperature or a crystallization temperature.

Examples described herein provide methods and a computer readable storage medium comprising instructions to control a 3D printing system. For example, methods to control a 3D printing system may comprise determining an amount of energy to be applied to a portion of a build material layer based on a reflectance of the portion. For example, a reflectance of the portion may be an estimated reflectance or a measured reflectance of the portion of the build material layer, such as of a portion of the build material layer with print agent deposited thereon. In some examples described herein, a predetermined or controlled amount of energy may be absorbed by portions of build material onto which energy absorbing print agent has been selectively deposited when uniformly applying the determined or adapted amount of energy. For example, portions of build material onto which energy absorbing print agent has been selectively deposited may heat to a predetermined temperature by adapting uniform energy application to a build material surface based on an estimated reflectance of that build material surface.

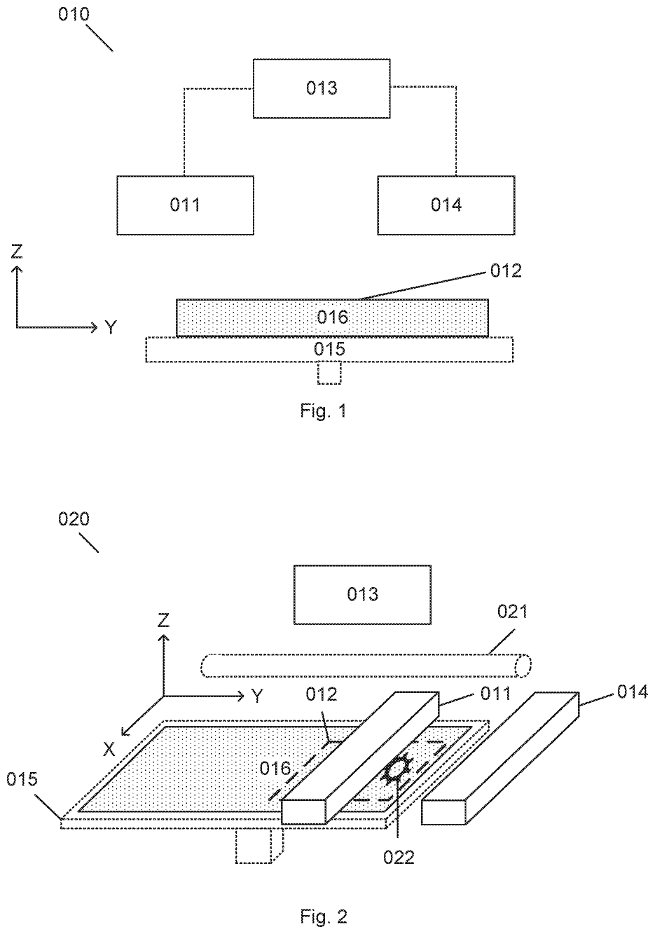

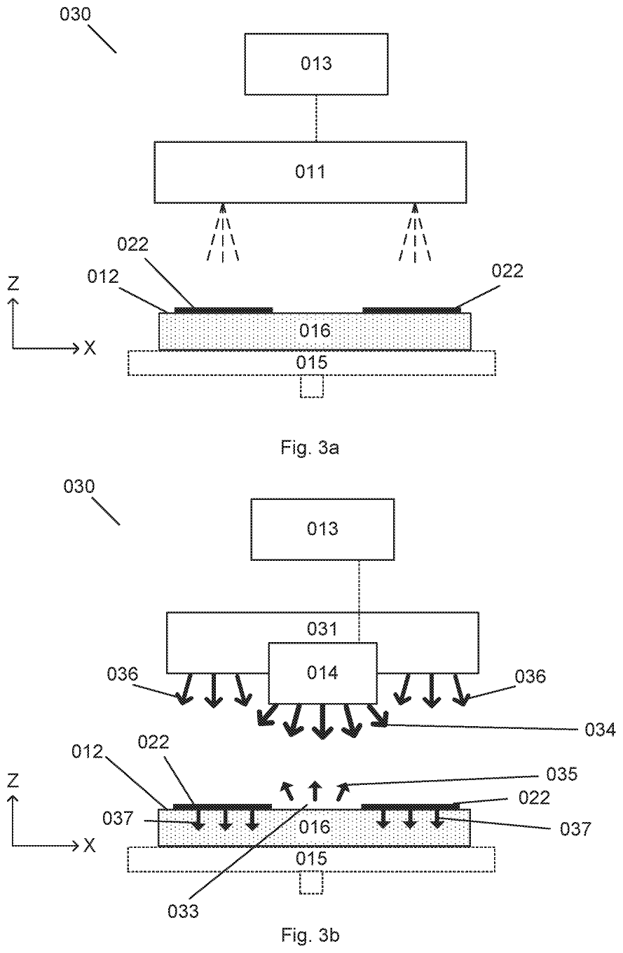

FIGS. 1 and 2 schematically show examples of a 3D printing system (010, 020) according to the examples described herein. The 3D printing system (010) may comprise a printhead (011) controllable to selectively deposit print agent onto a surface (012) of a build material layer (016) based on a three-dimensional object model. For example, FIG. 2 schematically shows a pattern (022) of deposited print agent by the printhead (011) onto the surface (012). The 3D printing system (010) may comprise a controller (013) to determine an amount of energy to be uniformly applied to the surface (012) based on a reflectance of that surface (012), such as based on a reflectance of the surface (012) and print agent to be deposited thereon. The 3D printing system (010) may comprise an energy source (014) to uniformly apply the determined amount of energy to the surface (012), such as onto the surface (012) and deposited print agent thereon. In some examples, the controller (013) may control the printhead (011), the energy source (014) and further components of the 3D printing system.

In some examples, the 3D printing system may comprise a build platform (015) onto which consecutive layers of build material may be formed. The build platform (015) may be movable in height, such as along a dimension (Z) as illustrated in FIG. 2, and may be moved downwards before a new layer of build material is formed on top of the previous layer, for example with a build material dispenser (021). The build material dispenser (021) may be a roller, a blade, a hopper, a nozzle or another suitable device, to form a build material layer (016) or a portion of a build material layer. For example, the build material dispenser (021) may be provided with an amount of build material and may be to spread a build material layer (016) when scanning over a previous layer or the build platform (015), such as for example along a dimension (X) as shown in FIG. 2.

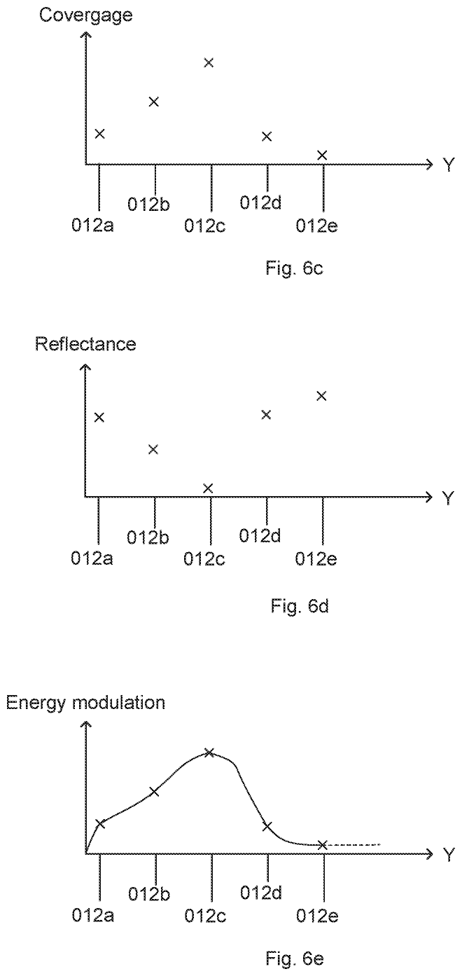

A surface (012) of a build material layer (016) for which a method as described herein may be performed may be the upper surface of the whole build material layer (016) formed on top of the build platform (015) or on top of a previous build material layer. In some examples, a surface (012) for which a method as described herein may be performed may be the upper surface of a portion of the build material layer (016), e.g. a stripe of the build material layer (016) as explained in the section referring to FIG. 6a or another surface portion of the build material layer (016), e.g, as illustrated in FIG. 2. In some examples, a method as described herein may be performed for a plurality of surfaces (012), e.g. a plurality of surface portions per build material layer (016) or a plurality of build material layers (016). A surface (012) of a build material layer (016) for which a method as described herein may be performed may comprise print agent deposited thereon by the printhead (011).

The printhead (011) may be scannable over the build platform (015) to deposit print agent onto the surface (012) of the build material layer (016), e.g. to selectively deposit print agent as controlled by the controller (013) based on a three-dimensional object model. In some examples, the printhead (011) may be scannable along a dimension over the build platform (015) to scan the whole width of the build platform (015), such as depicted in FIG. 2 showing a scannable printhead (011) to scan over a build platform (015) from right to left along a dimension (Y). The printhead (011) may also span the whole length of a build platform (015), for example as implemented in a page-wide configuration, such as illustrated in FIG. 2 where the printhead (011) may extend over the whole length of the build platform (015) along a dimension (X). For example, an array of nozzles of the printhead (011) may span over the whole length of a build material layer (016) and may be to selectively deposit print agent, such as in a pattern (022) based on a three-dimensional object model, when scanning over the width of the build material layer (016) as illustrated in FIG. 2. In some examples, the printhead (011) may be movable in two dimensions to scan the whole width and length of the build platform (015) or build material layer (016).

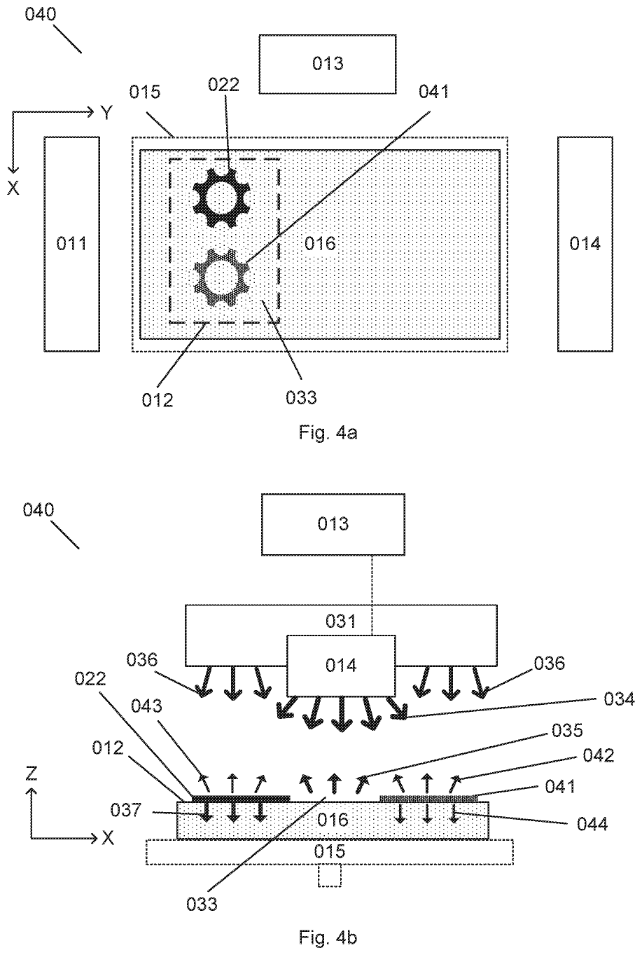

The printhead (011) may be an inkjet printhead, a nozzle array, a printhead assembly, a plurality of printheads, or a print agent dispenser. The printhead (011) may comprise a delivery structure and an ejection mechanism to deposit at least one print agent. In some examples, a plurality of printheads (011) may be to deposit each a print agent. For example, a print agent may be one of an energy absorbing print agent, fusing agent, coalescing agent, coloring agents, inks or other liquid agents. Print agent may comprise at least one of water, glycol, solvents, pigments, dyes, colorants, resins, lubricants, surfactants, additives and other components. Print agent may be deposited by the printhead (011) in a pattern (022) based on a three-dimensional object model, e.g. as illustrated in FIG. 2 and in a side-view of a 3D printing system (030) shown in FIG. 3a. For example, energy absorbing print agent may be deposited onto sections (022) of the surface (012) of the build material layer (016) based on a slice representation of a three-dimensional object model, such as on cross-sections. In some examples, print agent may be partially absorbed or may be soaked by the sections of the build material layer (016) onto which the print agent has been selectively deposited.

The energy source (014) may be to apply a determined amount of energy to the surface (012) after the printhead (011) may have deposited print agent in a pattern (022) onto the surface (012). In some examples, the energy source (014) may be scannable over the build platform (015) to apply energy onto the surface (012) of the build material layer (016) formed on the build platform (015). In some examples, the energy source (014) may be scannable over the build platform (015) to scan the whole width of the build platform (015), such as depicted in FIG. 2 showing a scannable energy source (014) to scan from right to left along a dimension (Y). The printhead (011) and the energy source (014) may be scannable along the same dimension, as depicted in FIG. 2, or along perpendicular dimensions. In some examples, the energy source (014) may span the whole length of the build platform (015), for example as illustrated in FIG. 2 where the energy source (014) may extend over the whole length of the build platform (015) along a dimension (X). In some examples, the energy source (014) may also be movable in two dimensions to scan the whole width and length of a build platform (015). In some examples, the energy source (014) may be an array of energy sources and may be fixed at a position, e.g. above the build platform (015). For example, the array of energy sources (014) may be to uniformly apply a determined amount of energy to the whole build material layer (016) at once.

The energy source (014) may be to emit electromagnetic radiation. For example, the energy source (014) may be a laser array, an ultra-violet source, an infra-red source, a visible light source, a halogen source, a fusing lamp, a broadband energy source ora heat source. In some examples, the energy source (014) may be to apply a determined amount of energy uniformly, or substantially uniformly, to a surface (012) of a build material layer (016). Uniform energy application onto a surface (012) may comprise a substantially constant amount of energy, e.g. substantially constant power, intensity, energy distribution, spectrum or time duration of energy application for all sections or points of that surface (012). For example, a scannable energy source (014), such as depicted in FIG. 2, may be to apply uniformly a determined amount of energy onto a surface portion of the build material layer (016), such as a stripe portion of the build material layer (016), below or perpendicularly below the energy source (014) when the energy source (014) is at a specific position. In some examples, a scannable energy source (014), such as depicted in FIG. 2, may be to apply uniformly a determined amount of energy to the whole surface of the build material layer (016) or to the surface portion (012) when the energy source (014) is to scan over the build material layer (016) or over the surface portion (012) while applying a constant amount of energy at each position.

FIG. 3b shows an example side-view of a 3D printing system (030) comprising an energy source (014) to apply a determined amount of energy to the surface (012) after a print agent was selectively deposited thereon. For example, a printhead (011) may have been controlled to deposit selectively print agent in a pattern (022) onto a surface (012), as shown in FIG. 3a, and sections (022) of the build material layer (016) onto which print agent has been selectively deposited may be soaked or imbued with print agent (not shown in FIGS. 3a and 3b). In some examples, when the energy source (014) may uniformly apply a determined amount of energy (034) onto the surface (012) of a build material layer (016), the applied energy (034) may be selectively absorbed and reflected by the surface (012). For example, sections (022) of the surface (012) onto which print agent or energy absorbing print agent has been deposited by a printhead (011) may absorb parts of the uniformly applied energy (034) from the energy source (014) and may transfer the absorbed energy (037), such as in the form of heat, to the underlying build material so that portions of build material may solidify.

In some examples, uniformly applied energy (034) from the energy source (014) may be partially reflected or scattered (035) from the surface (012) and may be radiated back to the energy source (014), a housing of the energy source (014) or other components of the 3D printing system (010) which may be attached over the surface (012), such as a reflector (031) shown in FIG. 3b. A reflector (031) may be plates, shields or flaps having a high reflectance. For example, a reflector (031) may be a part of the housing of the energy source (014). For example, a reflector (031) may be attached above a gas tube of a fusing lamp and may reflect energy to protect electronic components from heating up. The energy source (014), a housing of the energy source (014) or other components of the 3D printing system (010), such as a reflector (031) as discussed, may reflect or scatter, such as re-radiate, the energy partially or substantially completely back (036) again onto the surface (012).

This re-radiation of energy may cause an additional amount of energy to be indirectly applied to the surface (012). For example, a re-radiation effect may cause an additional amount of energy to be absorbed by the surface (012) and by fractions (022) of the surface (012) onto which print agent or energy absorbing print agent may has been deposited and may influence solidification processes of build material underlying those fractions (022), Methods and systems described herein may compensate or may account for this re-radiation effect by determining an amount of energy to be applied by the energy source (014) onto the surface (012) based on an estimated reflectance of that surface (012). For example, for a plurality of surfaces (012) a reflectance may vary and thus to account for a re-radiation effect an amount of energy may be adapted for each surface (012) based on the estimated reflectance.

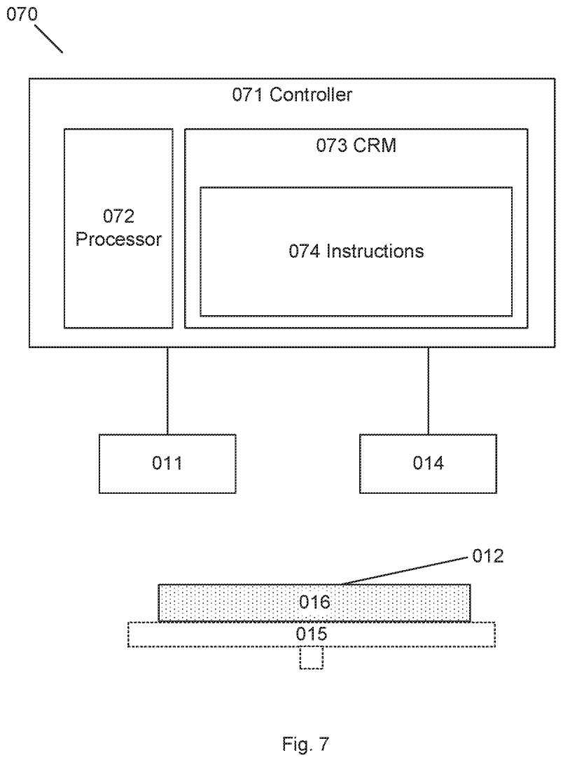

The controller (013) to determine an amount of energy to be uniformly applied to the surface (012) based on a reflectance of that surface (012), e.g. with print agent to be deposited on that surface (012), may be a microcontroller, an integrated circuit, an embedded system or any combination of circuitry and executable instructions representing a control program to perform a controlling operation as will be described in more detail with reference to FIG. 7, In some examples, the controller (013) may comprise circuitry to control the printhead (011) and the energy source (014). For example, the controller (013) may comprise circuitry to control the printhead (011) to selectively deposit print agent in a pattern, such as based on a three-dimensional object model. In some examples, the controller (013) may comprise circuitry to control a power supply which may be to supply power to the energy source (014) so that a determined amount of energy can be applied to the surface (012). In some examples, the printhead (011) and the energy source (014) may be controlled by another controller of the 3D printing system.

In some examples, the controller (013) may be to determine an amount of energy to be uniformly applied by the energy source (014) to be higher for a first reflectance than for a second reflectance if the first reflectance is lower than the second reflectance. For example, the higher the reflectance of the surface (012), the smaller the amount of energy to be applied uniformly by an energy source (014) so that a re-radiation effect is compensated or accounted for. In some examples, the controller (013) may be to determine an amount of energy to be applied by the energy source (014) onto the surface (012) to be directly or indirectly proportional to a reflectance of the surface (012). In some examples, the controller (013) may be to determine an amount of energy to be applied by the energy source (014) onto the surface (012) based on a linear function, quadratic function, cubic function or another polynomial function, e.g. a Taylor series, of a reflectance of the surface (012). In some examples, the controller (013) may be to determine an amount of energy based on a calibration or previous measurement data, such as a calibration of a melting temperature, a glass transition temperature or crystallization temperature of build material, and may be to adapt the amount of energy based on a reflectance of the surface (012).

A reflectance of a surface (012) of the build material layer (016) may depend on the reflectance properties of the build material comprised in the layer (016), reflectance properties of any print agent deposited by a printhead (011) onto the surface (012), a density or coverage of the surface (012) with print agent deposited by a printhead (011), a surface structure, such as surface roughness, the energy spectrum of the energy to be applied with an energy source (014) onto the surface (012), gas between the surface (012) and the energy source (014) and other factors which may influence energy transmission, reflectance or absorption. For example, a reflectance property of print agent selectively deposited on the surface (012) may depend on the color of the print agent or pigments within the print agent. The controller (013) may be to estimate a reflectance of the surface (012), e.g. based on at least one factor as discussed above, and may be to adapt an amount of energy accordingly. For example, the controller (013) may be to determine an amount of energy based on the factors influencing a reflectance of the surface (012). In some examples, the controller (013) may be to determine an amount of energy based on a reflectance measurement, such as based on a measured reflectance from the surface (012). For example, the controller (013) may be to receive a signal from a sensor measuring a reflectance property of the surface (012) and may be to determine based on the signal relating to a reflectance of the surface (012) an amount of energy to be applied onto the surface (012).

In some examples, build material formed as a build material layer (016) may be white or may have a bright color, e.g. such as plastic powder or polyamide powder and print agent to be selectively deposited by the printhead (011) may be black, such as carbon black ink. In some examples, print agent to be selectively deposited by the printhead (011) may be a colored or relatively clear energy absorbing print agent, such as an infrared absorbing agent or a low-tint fusing agent. Emitted energy of the energy source (014), e.g. of a fusing lamp, may be absorbed more by a surface fraction (022) with deposited print agent thereon than by a surface fraction (033) of the surface (012) of the build material layer (016) without print agent thereon, as illustrated in FIG. 3b. For example, a surface fraction (033) of the surface (012) without print agent thereon may have a higher reflectance, e.g. a higher reflectance per unit area, than a surface fraction (022) covered with print agent and the surface fraction (033) without print agent thereon may reflect partially energy back (035) when energy is uniformly applied by the energy source (014) onto the surface (012). An amount of the surface (012) covered or not covered with print agent may be a factor influencing an overall reflectance of the surface (012).

For example, the controller (013) may be to determine a reflectance of the surface (012) of the build material layer (016) based on the coverage of the surface (012) with print agent. In some examples, a controller (013) may be to determine from print instructions for the printhead (011) a fraction, an amount or area of the surface (012) to be covered with print agent or not to be covered with print agent. For example, the controller (013) may be to determine a fraction, e.g. percentage, of the surface (012) or a ratio of areas of the surface (012) to be covered or not to be covered with print agent. The controller (013) may be to relate a surface fraction of the surface (012) to be covered or not to be covered with print agent to an amount of energy to be applied for compensating or accounting for a re-radiation effect. For example, the controller (013) may be to determine the amount of energy to be uniformly applied to the surface (012) based on a fraction (033) of the surface (012) not to be covered with print agent and/or based on a fraction (022) of the surface (012) to be covered with print agent.

For example, the controller (013) may be to determine an amount of energy to be uniformly applied by the energy source (014) to be higher for a first fraction of the surface (012) covered, or to be covered, with print agent than for a second fraction of the surface (012) covered, or to be covered, with print agent if the first fraction is higher than the second fraction. For example, the higher the fraction of the surface (012) covered with print agent, such as with energy absorbing print agent, the higher the amount of energy to be applied uniformly by an energy source (014) so that a re-radiation effect is compensated or accounted for. In some examples, the controller (013) may be to determine an amount of energy to be applied by the energy source (014) onto the surface (012) to be directly or indirectly proportional to a fraction of the surface (012) to be covered with print agent. In some examples, the controller (013) may be to determine an amount of energy to be applied by the energy source (014) onto the surface (012) based on a linear function, quadratic function, cubic function or another polynomial function, e.g. a Taylor series, of a coverage with print agent of the surface (012). In some examples, the controller (013) may be to determine an amount of energy based on a calibration or previous measurement data, such as a calibration of a melting temperature, a glass transition temperature or crystallization temperature of build material, and may be to adapt the amount of energy based on a fraction of the surface (012) to be covered with print agent.

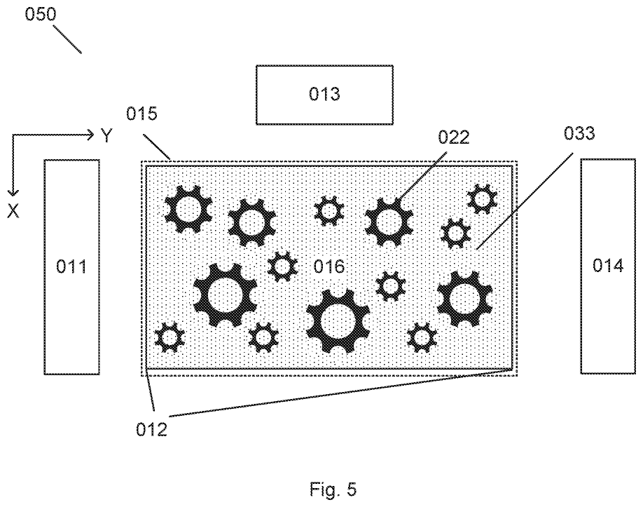

In some examples, a printhead (011) may be controllable to deposit a plurality of print agents. For example, detailing agent, also known as a coalescing modifier agent, may be deposited by the printhead (011) to modify properties of the build material, e.g. absorbance of radiation, heat transfer, heat capacity, etc., and may be distributed on sections of a surface (012) to decrease or modify heating or solidification of build material at these sections. Some print agents may comprise pigments and a printhead (011) may be to deposit coloring agents in a pattern onto the surface (012) to generate colored three-dimensional objects. For example, FIGS. 4a and 4b show examples of a 3D printing system (040) comprising a printhead (011) or a plurality of printheads to selectively deposit at least one further print agent onto a surface (012) of a build material layer (016). For example, a surface fraction (022) may be covered with a first print agent and a second surface fraction (041) may be covered with a second print agent.

For example, a surface fraction (022) covered with a first print agent may have a different or the same reflectance, e.g. a reflectance per unit area, than a second surface fraction (041) covered with a second print agent. For example, a first surface fraction (022) covered e.g. with energy absorbing print agent may mainly absorb (037) applied energy (034) and may reflect substantially no or a small amount of energy (043). A second surface fraction (041) covered with a second print agent may partially absorb (044) applied energy (034) and may partially reflect an amount of energy (042). A third surface fraction (033) covered with no print agent may substantially not absorb applied energy (034) or may absorb a small amount of energy and may mainly reflect an amount of energy (035). A controller (013) may be to estimate a reflectance of the surface (012) based on fractions of the surface (012) to be covered per print agent. For example, a controller (013) may be to determine an amount of energy to be applied to the surface (012) based on a fraction of the surface (012) to be covered per print agent, e.g. by selectively depositing a pattern per print agent with the printhead (011). For example, a controller (013) may be to determine an amount of energy to be applied to the surface (012) based on a reflectance property per print agent, e.g. such as based on a reflectance per unit area per print agent.

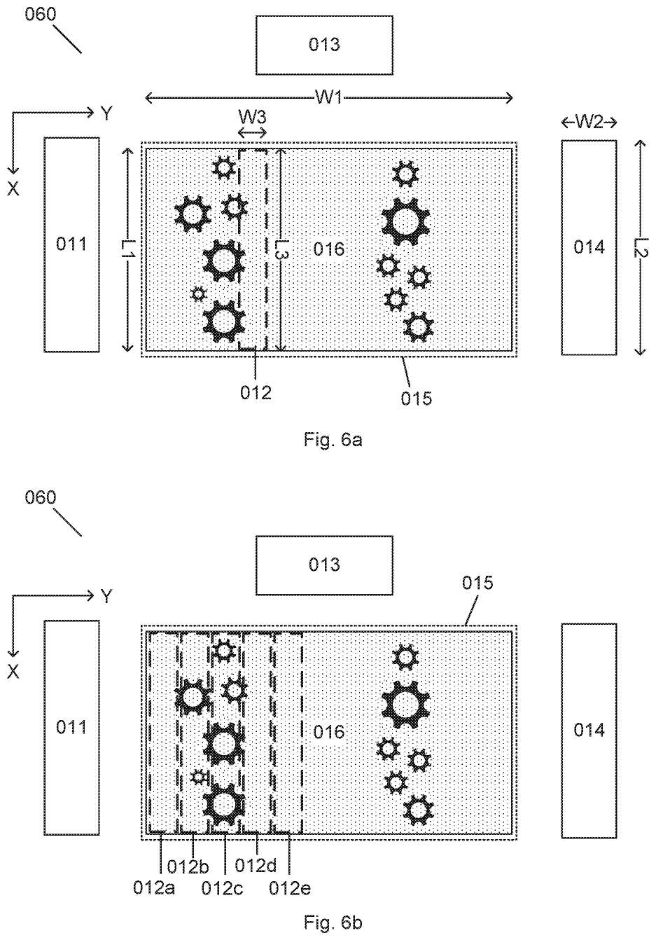

In some examples, a surface (012) of a build material layer for which methods described herein are applied may be the surface (012) of an entire build material layer (016), such as schematically shown in FIG. 5 depicting a top-view of a 3D printing system (050). The controller (013) may be to determine an amount of energy to be applied based on an estimated reflectance of the surface (012) of the entire build material layer (016), such as with print agent to be deposited thereon. For example, a reflectance may be substantially constant over the entire build material layer (016) or a re-radiation effect may be substantially constant or negligible over the entire surface (012) of the whole build material layer (016). This may be the case, for example, if print agent is to be deposited homogeneously or substantially uniformly over the surface (012) of the entire build material layer (016). In some examples, the energy source (014) may be an energy array and may be to apply, from a stationary position above the build platform (015), uniformly the determined amount of energy onto the surface (012) of the entire build material layer (016). In some examples, the energy source (014) may be a scannable energy source (014), e.g. as illustrated in FIG. 5, and may be to apply the determined amount of energy while scanning over the surface (012) of the entire build material layer (016). For example, a scannable energy source (014) may be to apply a constant energy while scanning over the build material layer (016) so that the determined amount of energy is uniformly applied to the entire surface (012) of the build material layer (016).

For example, a plurality of consecutive build material layers may be formed on a build platform (015) and onto the plurality of build material layers a printhead (011) may be to selectively deposit print agent. For example, per build material layer a surface fraction (022) to be covered with print agent may vary and per build material layer the controller (013) may be to determine an amount of energy to be applied based on the surface fraction to be covered with print agent. In some examples, per build material layer a print agent type may vary and per build material layer the controller (013) may be to determine an amount of energy to be applied based on an estimated reflectance, such as based on the surface fraction to be covered with print agent and the reflectance property of the print agent type.

In some examples, the surface (012) of the build material layer (016) for which methods as described herein are applied may be a stripe (012) of a build material layer (016), such as schematically shown in FIG. 6a illustrating a top-view of a 3D printing system (060). A stripe may be a surface portion (012) of the build material layer (016) extending over a length (L3) and a width (W3). In some examples, a stripe (012) may have a length (L3) extending over a full length (L1) of the build material layer (016). In some examples, an energy source (014) may have a length (L2) extending over the length (L3) of the stripe (012) so that the energy source (014) may apply energy uniformly over the length (L3) of the stripe, e.g, when a scannable energy source (014) is at a position above the stripe (012) of the surface of the build material layer (016). In some examples, the width (W3) of the stripe (012) may be smaller than the full width (W1) of the build material layer (016). In some examples, the width (W3) of the stripe (012) may be smaller than the width (W2) of a scannable energy source (014) so that the energy source (014) when positioned above the stripe (012) may be to apply uniformly a determined amount of energy at least onto the stripe (012). For example, the width (W3) of the stripe may be one pixel or a plurality of pixels, wherein a pixel may be a physical point or the smallest address-able location in a raster image representation per build material layer (016) or per slice of a three-dimensional object model.

The controller (013) may be to determine an amount of energy to be applied based on an estimated reflectance of the stripe (012) of the build material layer (016) and the energy source (014) may be to apply the determined amount of energy onto the stripe (012). In some examples, the controller (013) may be to determine an amount of energy to be applied for a series of stripes, such as for a plurality of parallel stripes over the build material layer (016). For example, as illustrated in FIG. 6b, a series of stripes (012a, 012b, 012c, 012d, 012e) may be discrete stripes of the surface of the build material layer (016) and the series may extend fully or partially over the build material layer (016), A controller (013) may be to determine an amount of energy to be applied for each stripe based on an estimated reflectance per stripe. For example, a reflectance may vary per stripe of a series of stripes (012a, 012b, 012c, 012d, 012e) or a reflectance may not be constant for all stripes of a series of stripes (012a, 012b, 012c, 012d, 012e). For example, a reflectance of the surface of a build material layer (016) may not be constant along a dimension (Y), so that a re-radiation effect may not be negligible when scanning an energy source (014) having a width (W2) along the dimension (Y).

For example, an energy source (014) as illustrated in FIGS. 6a and 6b may be a scannable energy array to apply uniformly energy along a dimension (X), such as over the whole length (L1) of the build material layer (016), and to scan along a dimension (Y), such as to scan along the width (W1) of the build material layer (016). The controller (013) may be to calculate an energy modulation along the dimension (Y) based on an estimated reflectance of the build material layer (016) along the dimension (Y), such as an estimated reflectance for a series of stripes (012a, 012b, 012c, 012d, 012e) along the dimension (Y). For example, each stripe of the series of stripes (012a, 012b, 012c, 012d, 012e) may have a width (W3) of at least one pixel and a reflectance may be an average or integrated value over the length (L3) per stripe. A calculated energy modulation by the controller (013) may to be applied by the energy source (014) when scanning over the build material layer (016) along the dimension (Y) over the build material layer (016).

For example, FIG. 6c schematically shows a graph depicting a coverage with print agent per stripe of a series of stripes (012a, 012b, 012c, 012d, 012e) of the build material layer (016). For example, a printhead (011) may be to selectively deposit print agent based on a three-dimensional object model and in some examples, a density or coverage with print agent to be deposited may not be constant along a dimension (Y). A reflectance along the dimension (Y) may relate to or may depend on the coverage with print agent, e.g. as schematically illustrated in FIG. 6d where a reflectance per stripe of the series of stripes (012a, 012b, 012c, 012d, 012e) is shown. The controller (013) may be to determine an amount of energy based on a coverage with print agent or a reflectance per stripe of the series of stripes (012a, 012b, 012c, 012d, 012e). In some examples, the controller (013) may be to determine an amount of energy based on a coverage with print agent or a reflectance, averaged or integrated over a dimension (X), per pixel along a dimension (Y). In some examples, the controller (013) may be to apply a kernel function, e.g. a gaussian filter or a smoothing function depending on the width (W2) of the energy source (014), to the series of determined amounts of energy to generate or calculate a continuous energy modulation, as shown in FIG. 6e. For example, a scannable energy source (014), such as illustrated in FIG. 6b, may be to apply the energy modulation while scanning over the build material layer (016) along a dimension (Y).

FIG. 7 shows an example of a controller (071), e.g. such as the controller (013) described in the sections for FIGS. 1-6. A controller (071) comprises a processor (072) having any appropriate circuitry capable of processing (e.g. computing) instructions, such as one or multiple processing elements, e.g, a central processing unit (CPU), a graphical processing unit (GPU), a semiconductorbased microprocessor, a programmable logic device (PLD), or the like. Processing elements may be integrated in a single device or distributed across devices. The controller (071) comprises a computer-readable storage medium (073) comprising instructions (074) to control a printhead assembly (011) to selectively deposit at least one print agent onto a surface (012) of build material (016) based on a three-dimensional model, instructions (074) to adapt an amount of electromagnetic radiation to be uniformly applied to the surface (012) of build material (016) based on a reflectance of the surface (012) and instructions (074) to control a fusing lamp (014) to apply the adapted amount of electro-magnetic radiation to the surface (012) of build material (016).

The computer readable storage medium (073) may comprise volatile, e.g. RAM, and non-volatile components, e.g. ROM, hard disk, CD-ROM, flash memory, etc. and may be an electronic, magnetic, optical, or other physical storage device that is capable of containing (i.e. storing) executable instructions (074). A storage medium (073) may be integrated in the same device as the processor (072) or it may be separate but accessible to the processor (072). The instructions (074) comprise instructions executable by the processor (071) and the instructions (074) may implement a method to control a 3D printing system (070). In some examples, the computer-readable storage medium (074) may further comprise instructions to control a build platform (015) and a build material dispenser (not shown in FIG. 7).

In some examples, instructions (074) may further comprise instructions to estimate the reflectance of the surface (012) based on a fraction of the surface (012) to be covered per print agent, e.g. as described in the sections for FIGS. 4a and 4b. In some examples, instructions (074) may further comprise instructions to estimate the reflectance of the surface (012) based on a reflectance per print agent, such as a reflectance per unit area per print agent. For example, instructions (074) may further comprise instructions to sum fractions of the surface (012) to be covered per print agent weighted with the respective reflectance per print agent to estimate a reflectance. In some examples, instructions (074) may further comprise instructions to estimate a reflectance based on a surface fraction of the surface (012) not covered by any print agent.

In some examples, instructions (074) may further comprise instructions to adapt or modify an amount of electro-magnetic radiation to be uniformly applied to the surface (012) of build material (016) to be higher for a first reflectance of the surface (012) than for a second reflectance if the first reflectance is lower than the second reflectance. In some examples, instructions (074) may further comprise instructions to determine an amount of electro-magnetic radiation to be uniformly applied based on a calibration, such as previous calibration measurements or empiric data. For example, a calibration table may comprise a relation between at least two of an amount of electro-magnetic radiation to be applied to a surface (012), a reflectance of the surface (012) and a coverage of the surface (012) with print agent.

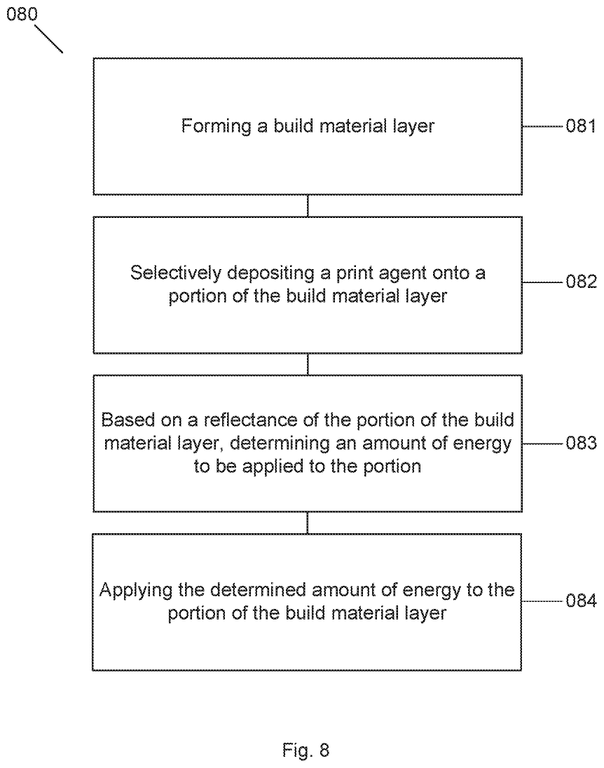

FIG. 8 schematically shows a flow diagram of an example of a method (080) to control a 3D printing system (070). The method (080) may be implemented as instructions of a controller (071) to control a system (070), as illustrated in FIG. 7 and in FIGS. 1-6. The method (080) includes forming a build material layer (081), selectively depositing a print agent onto a portion of the build material layer (082), based on a reflectance of the portion of the build material layer, determining an amount of energy to be applied to the portion (083), and applying the determined amount of energy to the portion of the build material layer (084). A portion of a build material layer may be a surface portion (012) as discussed in the sections for FIGS. 1 and 2, such as a surface portion (012) with print agent selectively deposited thereon. For example, a portion may be the entire surface of a build material layer such as discussed for FIG. 5, a stripe portion such as discussed for FIGS. 6a-6e or another surface portion of a build material layer.

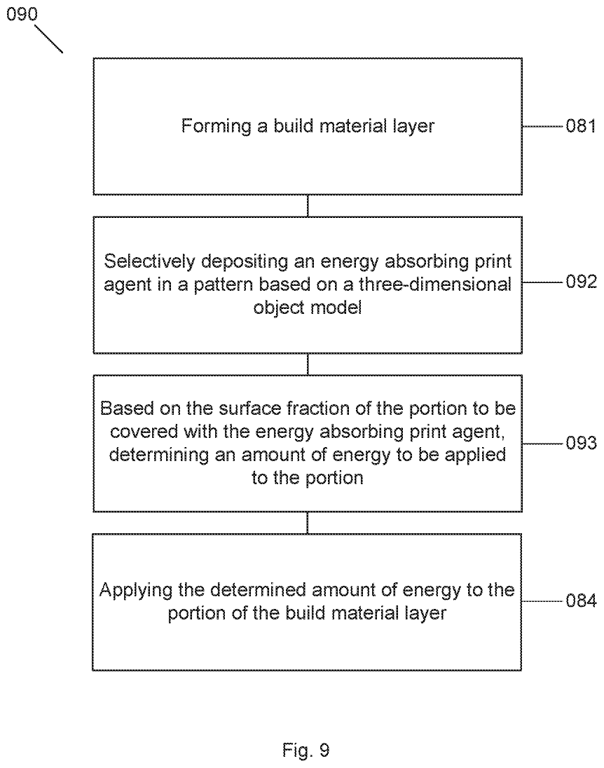

In some examples, as in a method (090) to control a 3D printing system schematically shown in FIG. 9 or any previous method, selectively depositing a print agent may comprise depositing an energy absorbing print agent in a pattern based on a three-dimensional object model (092). For example, the method (090) to control a 3D printing system or any previous method may further comprise determining an amount of energy to be applied to a portion based on the surface fraction of the portion to be covered with an energy absorbing print agent (093), such as discussed in sections of FIGS. 1-3.

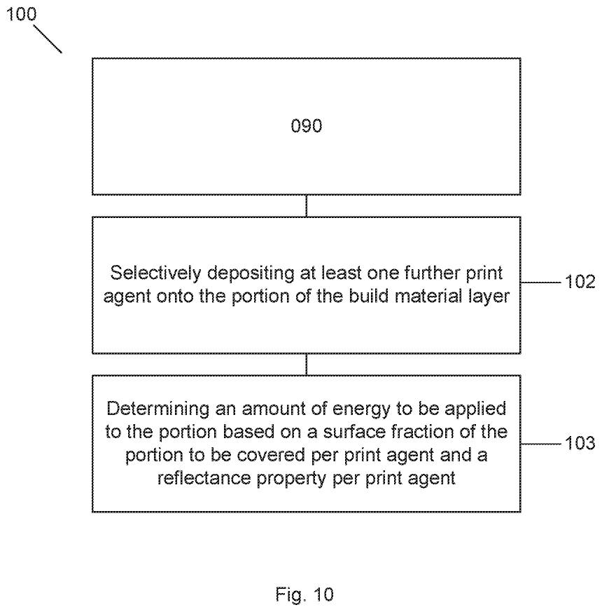

In some examples, as schematically shown in FIG. 10, a method (090) to control a 3D printing system or any previous method may further comprise selectively depositing at least one further print agent onto a portion of a build material layer (102) and determining an amount of energy to be applied to the portion based on a surface fraction of the portion to be covered per print agent and a reflectance property per print agent (103), e.g. as discussed in the sections for FIGS. 4a and 4b.

In some examples, a method (090) to control a 3D printing system or any previous method may further comprise applying with an energy source uniformly the determined amount of energy to a portion of the build material layer so that a surface fraction covered with energy absorbing print agent absorbs a predetermined amount of energy and heats to a predetermined temperature. For example, a predetermined amount of energy absorbed by a surface fraction covered with energy absorbing print agent comprises: a first part of energy received directly by an energy source and at least one re-radiated part of energy received indirectly by reflectors attached over the portion of the build material layer. Reflectors may re-radiate energy reflected back from a fraction of the portion not covered with energy absorbing print agent, such as for example discussed in the sections for FIG. 3b.

In some examples, for a method (090) to control a 3D printing system or for any previous method, determining an amount of energy to be applied to a portion of a build material layer based on a surface fraction of the portion to be covered with the energy absorbing print agent may further comprise determining a higher amount of energy to be applied to the portion for a first surface fraction to be covered with energy absorbing print agent than for a second surface fraction to be covered with energy absorbing print agent if the first surface fraction is higher than the second surface fraction.

In some examples of a method (080) to control a 3D printing system or of any previous method, a portion may be an entire build material layer, and an amount of energy to be applied to the entire build material layer may be based on a reflectance of the entire build material layer, such as discussed in sections of FIG. 5.

In some examples of a method (080) to control a 3D printing system or of any previous method a portion may be a stripe of a build material layer extending over a full length of the build material layer and a width smaller than the width of the build material layer. In some examples of a method (080) to control a 3D printing system or of any previous method an amount of energy to be applied to a stripe of a build material layer may be based on a reflectance of the stripe of the build material layer, such as described in sections of FIG. 6a.

In some examples, a method (080) to control a 3D printing system or any previous method may further comprise determining an amount of energy to be applied for each stripe of a series of discrete stripes of a build material layer based on an estimated reflectance per stripe and applying a kernel function to the determined amounts of energy for the series of discrete stripes to generate a continuous energy modulation, e.g. as described in sections of FIGS. 6b-6e. In some examples, a method (080) to control a 3D printing system or any previous method may further comprise scanning an energy source over the build material layer to apply the continuous energy modulation onto the build material layer.

The following terminology is understood to mean the following when recited by the description or the claims. The word “comprising” does not exclude the presence of elements other than those listed, the word “including” or “having” does not exclude the presence of elements other than those listed, “a”, “an” or “the” does not exclude a plurality and a “series” or “plurality” does not exclude a singularity. The words “or” and “and” have the combined meaning “and/or” except combinations of listed features where at least some of such features and/or elements are mutually exclusive within the context.

All of the features disclosed in the claims and description (including drawings), and/or all of the elements of any method or process so disclosed, may be combined in any combination and order, except combinations where at least some of such features and/or elements are mutually exclusive.

1. A method of controlling a 3D printing system comprising:
forming a build material layer;
selectively depositing a print agent onto a portion of the build material layer;
based on a reflectance of the portion of the build material layer, determining an amount of energy to be applied to the portion; and
applying the determined amount of energy to the portion of the build material layer.

2. The method of claim 1,
wherein selectively depositing the print agent comprises depositing an energy absorbing print agent in a pattern based on a three-dimensional object model,
and wherein determining an amount of energy to be applied to the portion is based on the surface fraction of the portion to be covered with the energy absorbing print agent.

3. The method of claim 2, further comprising:
selectively depositing at least one further print agent onto the portion of the build material layer; and
determining an amount of energy to be applied to the portion based on a surface fraction of the portion to be covered per print agent and a reflectance property per print agent.

4. The method of claim 2, further comprising:
applying with an energy source uniformly the determined amount of energy to the portion of the build material layer so that the surface fraction covered with energy absorbing print agent absorbs a predetermined amount of energy and heats to a predetermined temperature,
wherein the predetermined amount of energy absorbed by the surface fraction covered with energy absorbing print agent comprises of:
a first part of energy received directly by the energy source; and
at least one re-radiated part of energy received indirectly by reflectors attached over the portion of the build material layer, the reflectors reradiating energy reflected back from a fraction of the portion not covered with energy absorbing print agent.

5. The method of claim 2, wherein determining an amount of energy to be applied to the portion based on the surface fraction of the portion to be covered with the energy absorbing print agent comprises:
determining a higher amount of energy to be applied to the portion for a first surface fraction to be covered with energy absorbing print agent than for a second surface fraction to be covered with energy absorbing print agent if the first surface fraction is higher than the second surface fraction.

6. The method of claim 1,
wherein the portion is an entire build material layer,
and wherein an amount of energy to be applied to the entire build material layer is based on a reflectance of the entire build material layer.

7. The method of claim 1,
wherein the portion is a stripe of a build material layer extending over a full length of the build material layer and a width smaller than the width of the build material layer,
and wherein an amount of energy to be applied to the stripe of the build material layer is based on a reflectance of the stripe of the build material layer.

8. The method of claim 6, further comprising:
for a series of discrete stripes of a build material layer determining an amount of energy to be applied for each stripe based on a reflectance per stripe;
applying a kernel function to the determined amounts of energy for the series of discrete stripes to generate a continuous energy modulation; and scanning an energy source over the build material layer to apply the continuous energy modulation onto the build material layer.

9. A 3D printing system comprising:
a printhead controllable to selectively deposit a print agent onto a surface of a build material layer based on a three-dimensional object model;
a controller to determine an amount of energy to be uniformly applied to the surface based on a reflectance of that surface; and
an energy source to uniformly apply the determined amount of energy to the surface.

10. The system of claim 8,
wherein the energy source is in a housing comprising a reflector,
and wherein when the energy source is to uniformly apply the determined amount of energy to the surface, and wherein the reflector may at least partially reflect energy reflected from the surface back onto the surface of the build material layer.

11. The system of claim 8,
wherein the controller is to determine the amount of energy to be uniformly applied to the surface based on a fraction of the surface not to be covered with print agent,
and wherein the fraction of the surface not covered with print agent has a higher reflectance than another fraction of the surface covered with print agent.

12. The system of claim 8,
wherein the energy source is a scannable energy source to uniformly apply energy along a first dimension of the build material layer and to scan along a second dimension over the build material layer,
and wherein the controller is to calculate an energy modulation along the second dimension based on a reflectance of the build material layer along the second dimension so that an energy modulation may be applied over the build material layer along the second dimension.

13. A non-transitory computer readable storage medium comprising instructions that, when executed by a processor, cause the processor to:
control a printhead assembly to selectively deposit at least one print agent onto a surface of build material based on a three-dimensional object model;
adapt an amount of electro-magnetic radiation to be uniformly applied to the surface of build material based on a reflectance of the surface; and
control a fusing lamp to apply the adapted amount of electro-magnetic radiation to the surface of build material.

14. The non-transitory computer readable storage medium of claim 13, further comprising instructions that, when executed by a processor, cause the processor to:
estimate the reflectance of the surface based on a fraction of the surface to be covered per print agent and a reflectance per print agent.

15. The non-transitory computer readable storage medium of claim 13, further comprising instructions that, when executed by a processor, cause the processor to:
adapt an amount of electromagnetic radiation to be uniformly applied to the surface of build material to be higher for a first reflectance of the surface than for a second reflectance if the first reflectance is lower than the second reflectance.
